(19) United States
(12) Patent Application Publication
(10) Pub. No.: US 2015/0137743 A1
(43) Pub. Date: May 21, 2015

(54) WIRELESS CHARGING SYSTEM AND WIRELESS CHARGING METHOD

(71) Applicants: Inventec (Pudong) Technology Corporation, Shanghai (CN); INVENTEC CORPORATION, Taipei City (TW)

(72) Inventor: Chih-Kuo LU, TAIPEI CITY (TW)

(73) Assignees: Inventec (Pudong) Technology Corporation, Shanghai (CN); INVENTEC CORPORATION, Taipei City (TW)

(21) Appl. No.: 14/249,355

(22) Filed: Apr. 10, 2014

(30) Foreign Application Priority Data
Nov. 20, 2013 (CN) 201310589529.7

(51) Int. Cl. H02J 7/02; H02J 7/00

(52) U.S. Cl. CPC H02J 7/025; H02J 7/0052; H02J 7/007
USPC 320/108; 320/137

(57) ABSTRACT

A wireless charging system, which includes a chargeable element and a wireless power supply, is provided. The wireless power supply is configured for generating a wireless power signal to charge the chargeable element, in which the wireless power supply is further configured for detecting a power type required by the chargeable element, and for adjusting the wireless power signal according to the detected power type. A wireless charging method is disclosed herein as well.

### RELATED APPLICATIONS

This application claims priority to Chinese Application Serial Number 201310589529.7, filed Nov. 20, 2013, which is herein incorporated by reference.

### BACKGROUND

1. Technical field

The present disclosure relates to a wireless charging system and a wireless charging method. More particularly, the present disclosure relates to a power-adjustable wireless charging device and wireless charging method.

2. Description of Related Art

A wireless charger is a charging device without using charging power cables. By using the wireless charger, the trouble of getting twisted power cables is avoided. The risks of getting electric shocks could also be reduced since there is no electrode exposed on the wireless charger. However, conventional wireless chargers can only charge devices at a fixed power. Therefore, a wireless charger can only charge a few specific devices, and is not suitable for various kinds of devices.

### SUMMARY

In one aspect, the present disclosure is related to a wireless charging system. The wireless charging system includes a chargeable element and a wireless power supply. The wireless power supply is configured for generating a wireless power signal to charge the chargeable element. The wireless power supply is further configured for detecting a power type required by the chargeable element, and for adjusting the wireless power signal according to the detected power type.

In another aspect, the present disclosure is related to a wireless charging method, which includes the following steps: detecting a power type required by a chargeable element; adjusting a wireless power signal generated by a wireless power supply according to the detected power type; and charging the chargeable element with the adjusted wireless power signal.

These and other features, aspects, and advantages of the present disclosure will become better understood with reference to the following description and appended claims.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows.

FIG. 1 is a schematic diagram of a wireless charging system in accordance with one embodiment of the present disclosure;

FIG. 2 is a schematic diagram of a wireless charging system in accordance with one embodiment of the present disclosure;

FIG. 3 is a schematic diagram of a wireless charging system in accordance with one embodiment of the present disclosure;

FIG. 4 is a schematic diagram of a wireless charging system in accordance with one embodiment of the present disclosure;

FIG. 5 is a schematic diagram of a wireless charging system in accordance with one embodiment of the present disclosure;

FIG. 6 is a schematic diagram of a wireless charging system in accordance with one embodiment of the present disclosure;

FIG. 7 is a flow chart of a wireless charging method in accordance with one embodiment of the present disclosure;

FIG. 8 is a flow chart of a wireless charging method in accordance with one embodiment of the present disclosure;

FIG. 9 is a flow chart of a wireless charging method in accordance with one embodiment of the present disclosure;

FIG. 10 is a flow chart of a wireless charging method in accordance with one embodiment of the present disclosure;

FIG. 11 is a flow chart of a wireless charging method in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

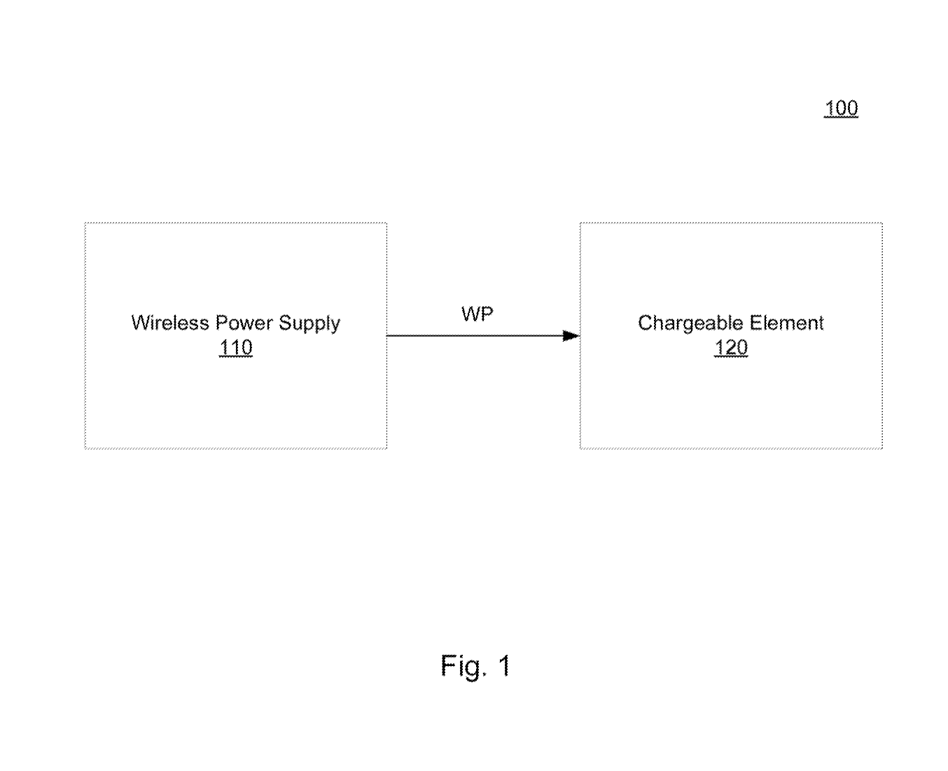

FIG. 1 is a schematic diagram of a wireless charging system 100 in accordance with one embodiment of the present disclosure.

The wireless charging system 100 includes a wireless power supply 110 and a chargeable element 120. The wireless power supply 110 is configured for generating a wireless power signal WP to charge the chargeable element 120. The wireless power supply 110 is further configured for detecting a power type required by the chargeable element 120, and for adjusting the wireless power signal WP according to the detected power type.

In an embodiment of the present disclosure, the chargeable element 120 can be a handheld electronic device, for example, a smart phone, a tablet computer, a digital camera, a laptop, a MP3/MP4 player or a GPS navigation device. The wireless power supply 110 provides and supplies wirelessly electrical power required by the electronic device to function. In another embodiment, the chargeable element 120 can be a removable power module of a electronic system for supplying power to the electronic system, and the wireless power supply 110 provides and supplies wirelessly electrical power to the removable power module. In another embodiment, the chargeable element 120 can be a mobile power (i.e., a power bank), and the wireless power supply 110 provides and supplies wirelessly electrical power to the mobile power. In one another embodiment, the chargeable element 120 can be a car, the wireless power supply 110 provides and supplies wirelessly electrical power required by the car to function.

In an example, the chargeable element 120 is a smart phone, which can be charged wirelessly. The wireless power supply 110 detects the power type required by the smart phone to be a 5 watt electrical power, and the wireless power supply 110 outputs a 5 watt wireless power signal WP accordingly to charge the smart phone. In another example, the chargeable element 120 is a tablet computer, which can be charged wirelessly. The wireless power supply 110 detects the power type required by the tablet computer to be a 15 watt electrical power, and the wireless power supply 110 outputs a 15 watt wireless power signal WP accordingly to charge the tablet computer.

In one another example, the chargeable element 120 is a laptop, which can be charged wirelessly. The wireless power supply 110 detects the power type required by the laptop to be a 30 watt electrical power, and the wireless power supply 110 outputs a 30 watt wireless power signal WP accordingly to charge the laptop. After charging the laptop for a period of time, the laptop detects that the power of its battery has reached a setting value (for example, 95%), and the laptop adjusts the required power type to be a 20 watt electrical power accordingly. The wireless power supply 110 lowers down the power of the wireless power signal WP to 20 watt after detecting the adjusted required power type.

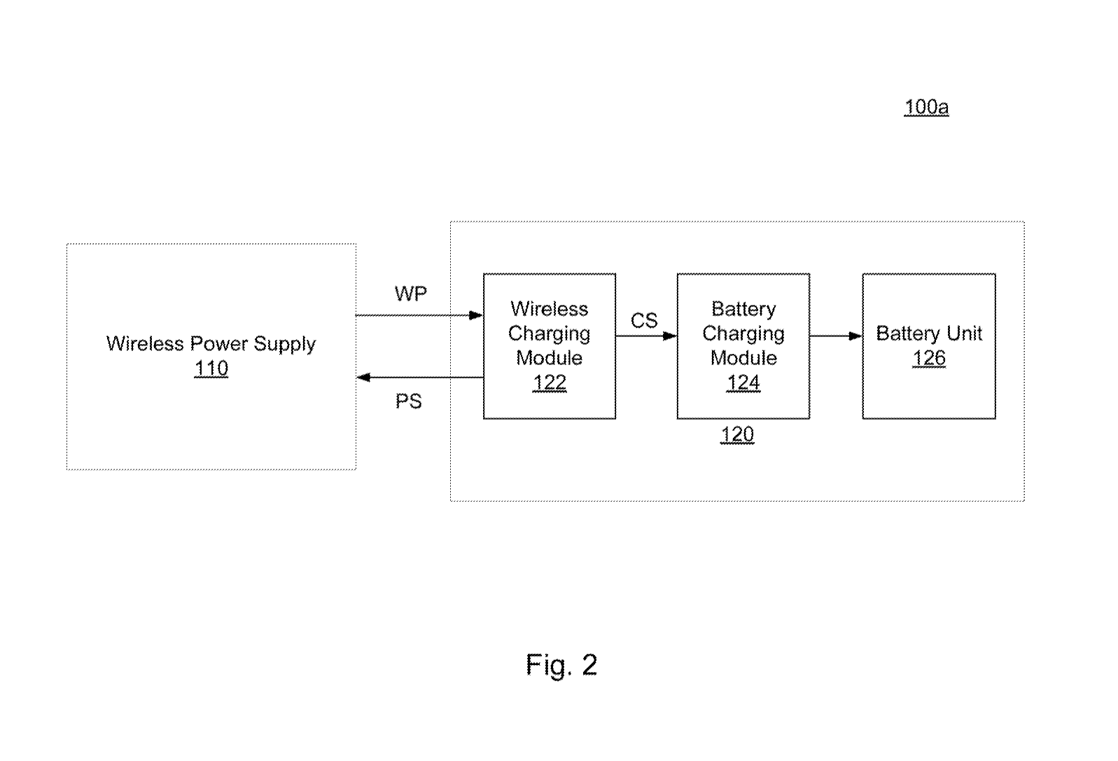

FIG. 2 is a schematic diagram of a wireless charging system 100a in accordance with one embodiment of the present disclosure. The wireless charging system 100a is similar to the wireless charging system 100 illustrated in FIG. 1, and the wireless charging system 100a also includes the wireless power supply 110 and the chargeable element 120. In this embodiment, the chargeable element 120 further includes a wireless charging module 122, a battery charging module 124 and a battery unit 126. The wireless charging module 122 is electrically connected with the battery charging module 124, in which the wireless charging module 122 is configured for outputting a power signal PS corresponding to the power type required by the chargeable element 120, and for receiving the wireless power signal WP to generate a charging signal CS. The battery charging module 124 is electrically connected with the wireless charging module 122 and the battery unit 126, in which the battery charging module 124 is configured for charging the battery unit 126 according to the charging signal CS.

In an embodiment of the present disclosure, each of the wireless power supply 110 and the wireless charging module 122 includes an inductive coil (not depicted). By utilizing electromagnetic induction between the two coils, the wireless power supply 110 provides the wireless power signal WP for the wireless charging module 122, and the wireless charging module 122 transmits the power signal PS to the wireless power supply 110. In the present embodiment, the wireless charging module 122 converts the wireless power signal WP to the charging signal CS, and provides the charging signal CS for the battery charging module 124. The battery charging module 124 then charges the battery unit 126 according to the charging signal CS.

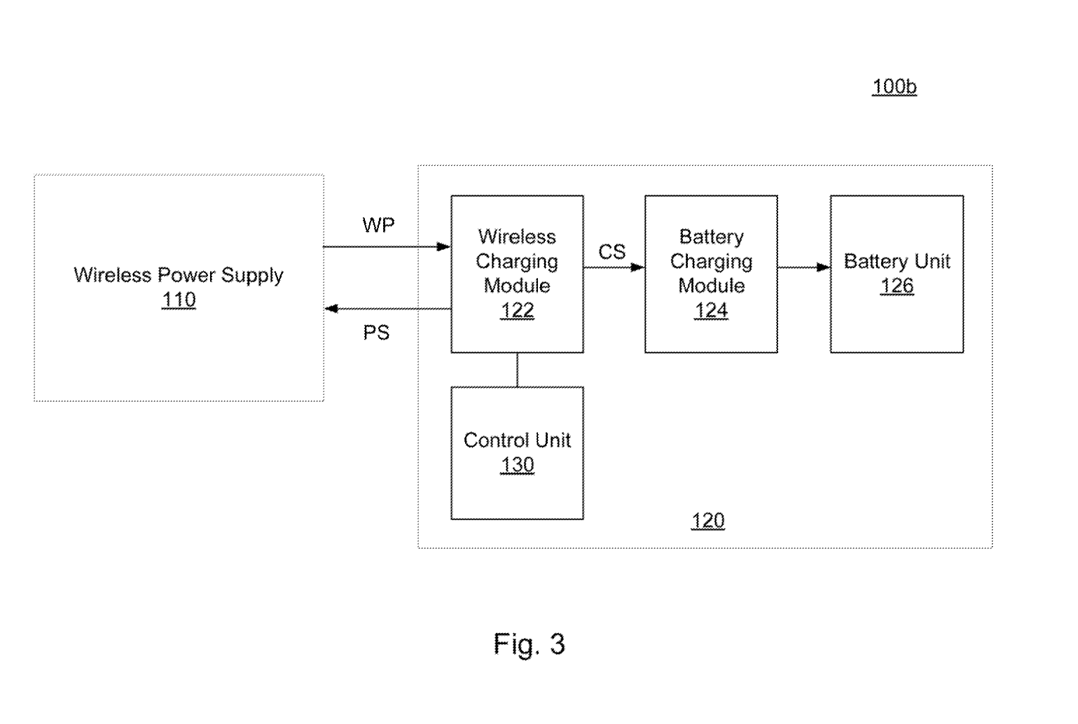

FIG. 3 is a schematic diagram of a wireless charging system 100b in accordance with one embodiment of the present disclosure. Comparing with the wireless charging system 100a illustrated in FIG. 2, the chargeable element 120 in the wireless charging system 100b further includes a control unit 130. The control unit 130 is electrically connected with the wireless charging module 122, in which the control unit 130 is configured for controlling the wireless charging module 122 to adjust the power signal PS.

In an embodiment of the present disclosure, when the power stored in the battery unit 126 becomes low, the control unit 130 controls the wireless charging module 122 to adjust the power signal PS such that the adjusted power signal corresponds to a higher power requirement (for example, 15 watt). On the other hand, when the power stored in the battery unit 126 reaches a setting value, the control unit 130 controls the wireless charging module 122 to adjust the power signal PS such that the adjusted power signal corresponds to a lower power requirement (for example, 10 watt).

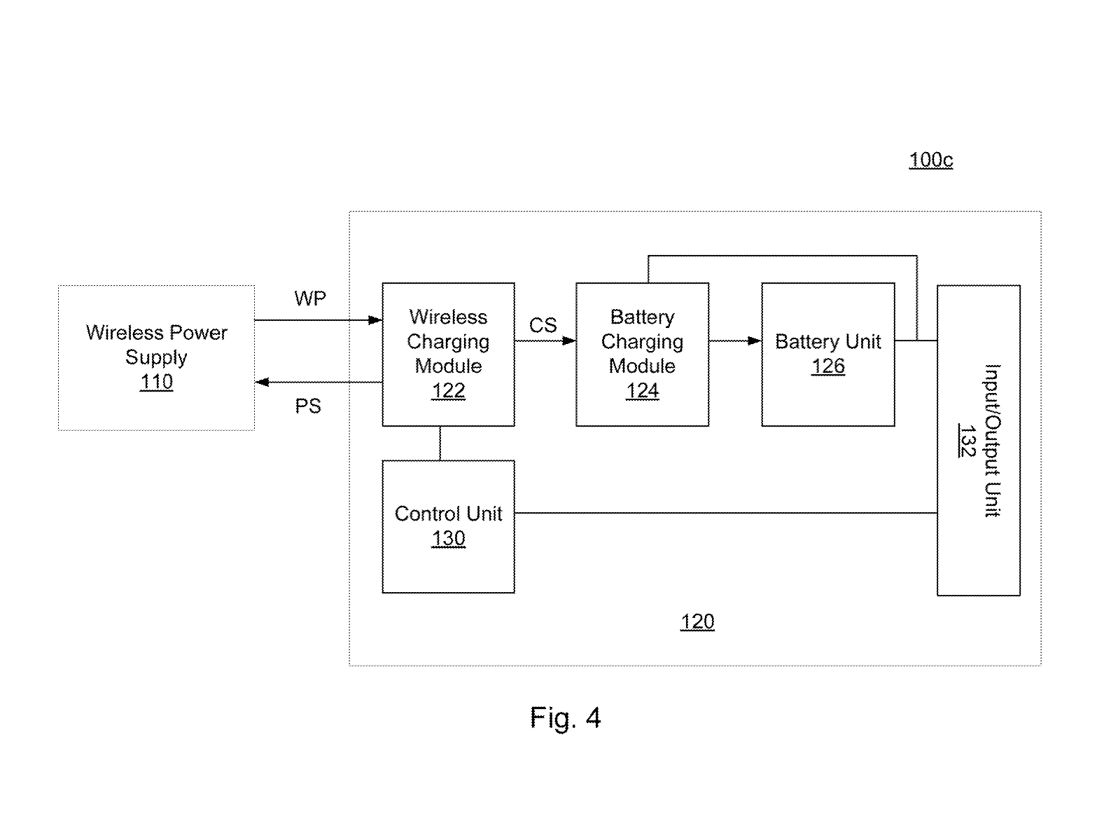

FIG. 4 is a schematic diagram of a wireless charging system 100c in accordance with one embodiment of the present disclosure. Comparing with the wireless charging system 100b illustrated in FIG. 3, the chargeable element 120 in the wireless charging system 100c further includes an input/output unit 132. The input/output unit 132 is electrically connected with the battery charging module 124, the battery unit 126 and the control unit 130, in which the input/output unit 132 is configured for receiving external signals, external power supply, or outputting internal information. The input/output unit 132 could be a I²C bus, a USB bus or other buses. Skilled persons can choose appropriate bus to implement the input/output unit 132.

In an embodiment of the present disclosure, the input/output unit 132 is configured for receiving a system control signal and for transmitting the received control signal to the control unit 130. The control unit 130 then controls the wireless charging module 122 to adjust the power signal PS according to the received control signal to realize the corresponding change of the power of the wireless power signal WP. In the present embodiment, the input/output unit 132 is further configured for outputting a charging information, in which the charging information includes but not limited to the remaining power of the battery unit 126, the power of the wireless power signal WP, the temperature of the battery unit 126 or the charging power provided by the battery charging module 124 for the battery unit 126. The system or users could send a control signal according to the charging information to the control unit 130 through the input/output unit 132 to realize a corresponding change of the power of the wireless power signal WP.

In another embodiment of the present disclosure, the input/output unit 132 is connected with an external power supply, in which the input/output unit 132 is configured for transmitting the external power supply to the battery charging module 124 to charge the battery unit 126. For example, when it is not able to use the wireless power supply 110, users can charge the battery unit 126 by inputting an external power through the input/output unit 132.

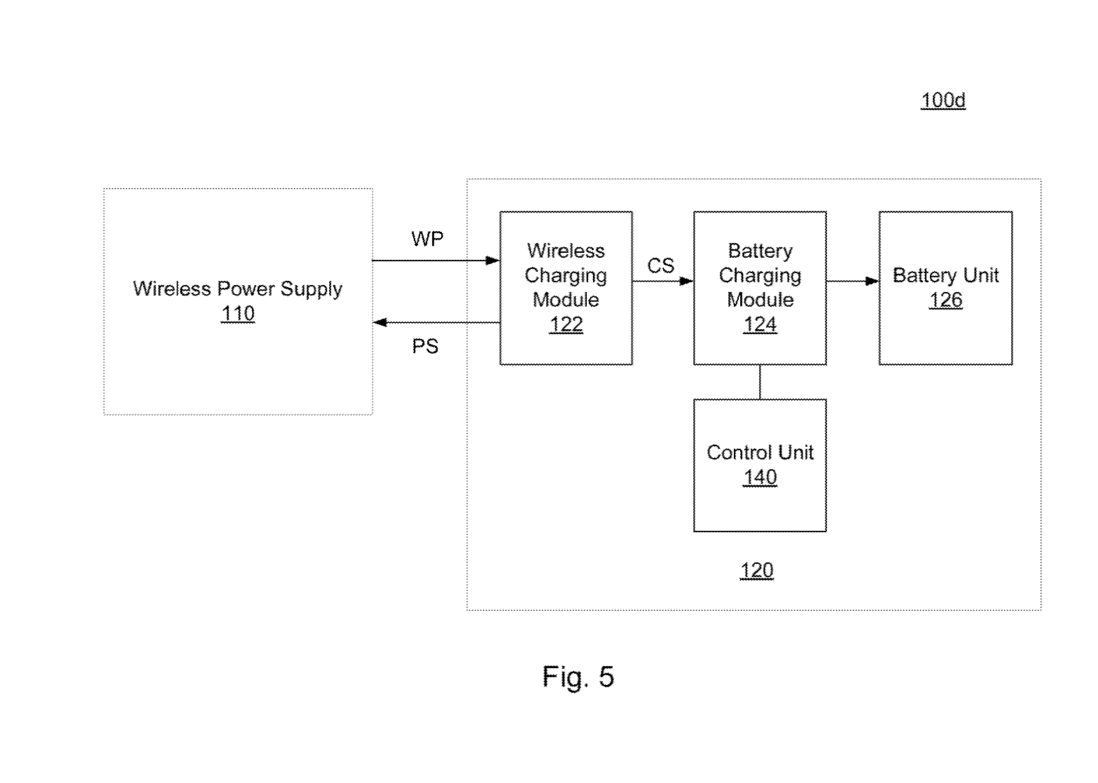

FIG. 5 is a schematic diagram of a wireless charging system 100d in accordance with one embodiment of the present disclosure. Comparing with the wireless charging system 100a illustrated in FIG. 2, the chargeable element 120 in the wireless charging system 100d further includes a control unit 140. The control unit is electrically connected with the battery charging module 124, in which the control unit 140 is configured for controlling the battery charging module 124 to adjust charging power to charge the battery unit 126.

In an embodiment of the present disclosure, when the power stored in the battery unit 126 becomes reaches a high setting value, the control unit 140 controls the battery charging module 124 to lower down the charging power to charge the battery unit 126. On the other hand, when the power stored in the battery unit 126 reaches a low setting value, the control unit 140 controls the battery charging module 124 to increase the charging power to charge the battery unit 126.

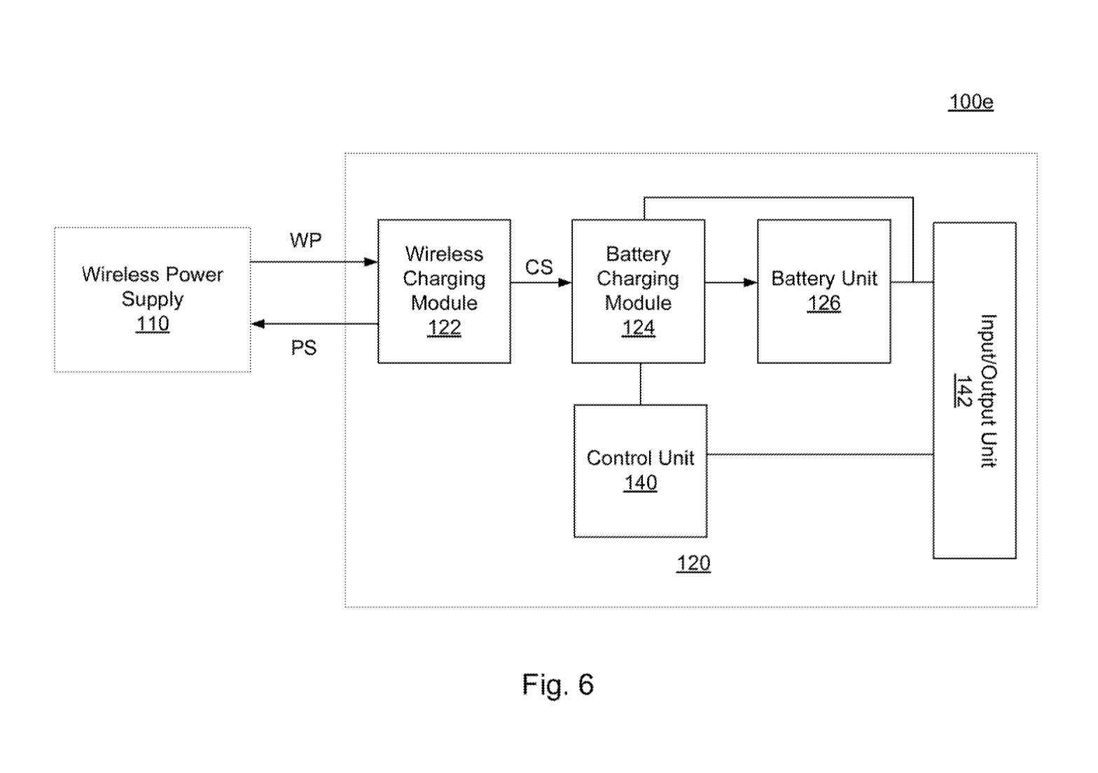

FIG. 6 is a schematic diagram of a wireless charging system 100e in accordance with one embodiment of the present disclosure. Comparing with the wireless charging system 100d illustrated in FIG. 5, the chargeable element 120 in the wireless charging system 100e further includes an input/output unit 142. The input/output unit 142 is electrically connected with the battery charging module 124, the battery unit 126 and the control unit 140, in which the input/output unit 142 is configured for receiving external signals, external power supply, or outputting internal information.

In an embodiment of the present disclosure, the input/output unit 142 is configured for receiving a system control signal and for transmitting the received control signal to the control unit 140. The control unit 140 then controls the battery charging module 124 to adjust the charging power to charge the battery unit 126. in the present embodiment, the input/output unit 142 is further configured for outputting a charging information, in which the charging information includes but not limited to the remaining power of the battery unit 126, the temperature of the battery unit 126 or the charging power provided by the battery charging module 124 for the battery unit 126. The system or users could send a control signal according to the charging information to the control unit 140 through the input/output unit 142 to realize a corresponding adjustment of the charging power provided by the battery charging module 124 for the battery unit 126.

In another embodiment of the present disclosure, the input/output unit 142 is connected with an external power supply, in which the input/output unit 142 is configured for transmitting the external power supply to the battery charging module 124 to charge the battery unit 126.

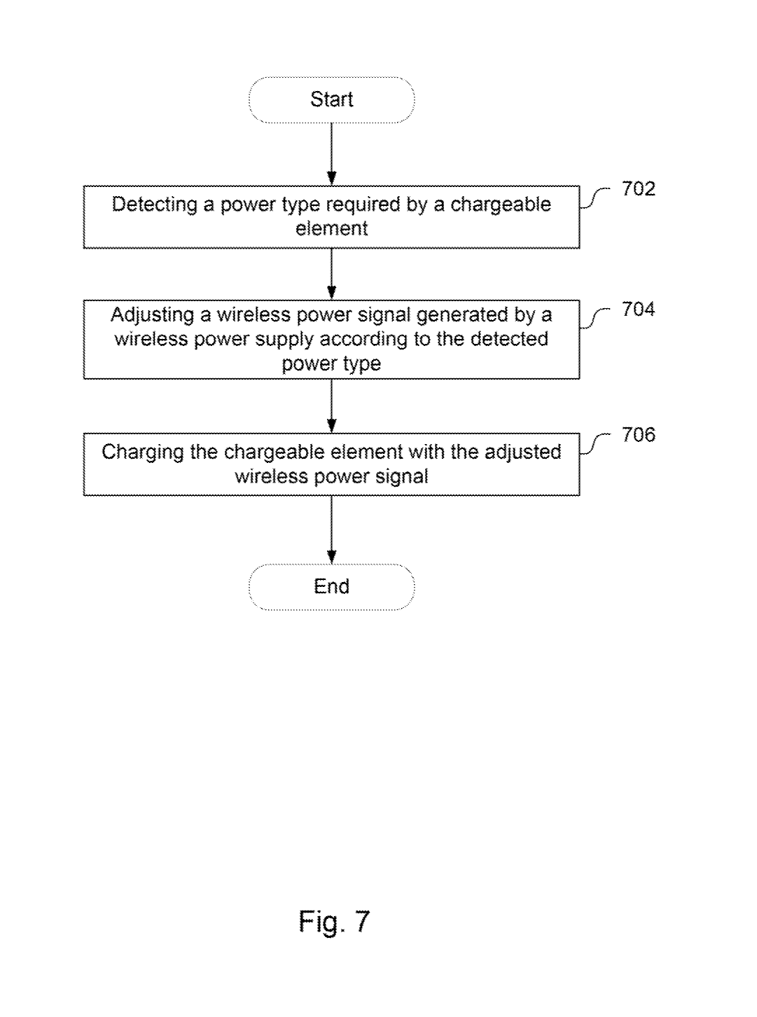

FIG. 7 is a flow chart of a wireless charging method in accordance with one embodiment of the present disclosure. The wireless charging method could be applied in the wireless charging system 100 illustrated in FIG. 1 and is not limited herein. Specifically, the wireless charging method illustrated in FIG. 7 corresponds to operations on power supplies and could be applied but not limited to the wireless power supply 110 illustrated in FIG. 1. For convenience and clarity, the following description about the wireless charging method is illustrated based on the wireless charging system 100 illustrated in FIG. 1.

In step 702, the wireless power supply 110 detects a power type required by the chargeable element 120. Then in step 704, the wireless power supply 110 adjusts the wireless power signal WP according to the detected power type. After that, in step 706, the wireless power supply 110 charges the chargeable element 120 with the adjusted wireless power signal WP.

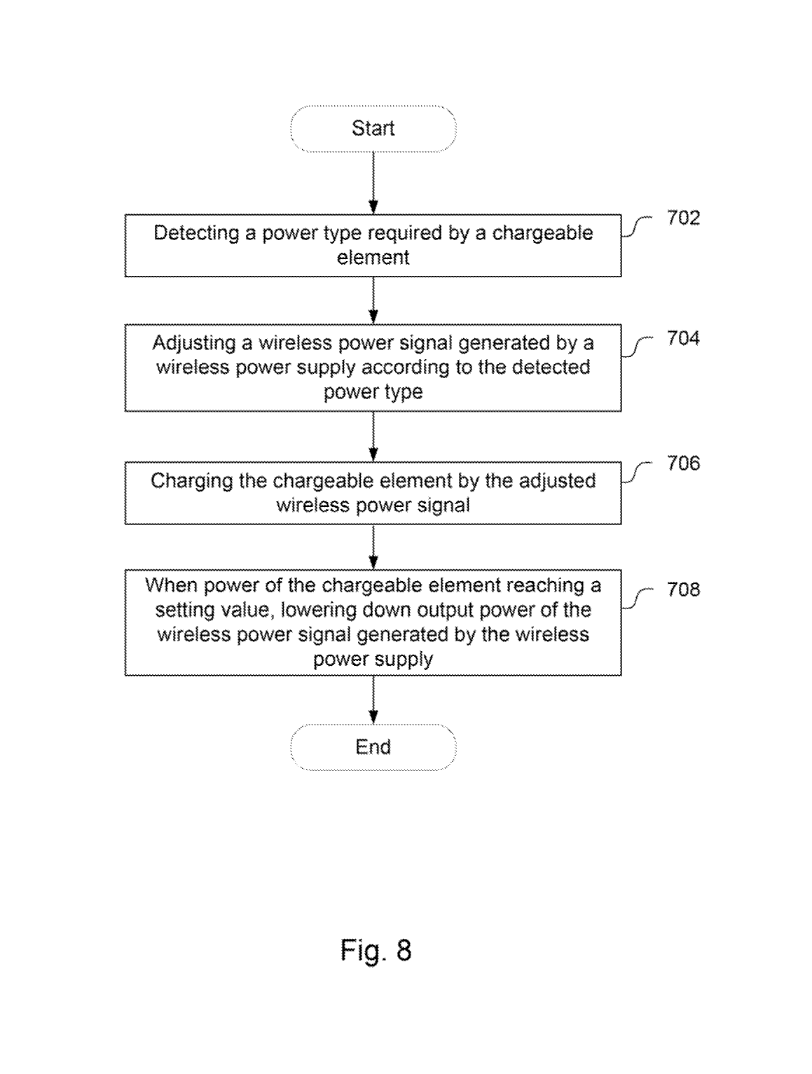

FIG. 8 is a flow chart of a wireless charging method in accordance with one embodiment of the present disclosure. Comparing with the wireless charging method illustrated in FIG. 7, in the present embodiment, the wireless charging method further includes step 708. In step 708, when power of the chargeable element 120 reaches a setting value, lower down output power of the wireless power signal WP generated by the wireless power supply 110.

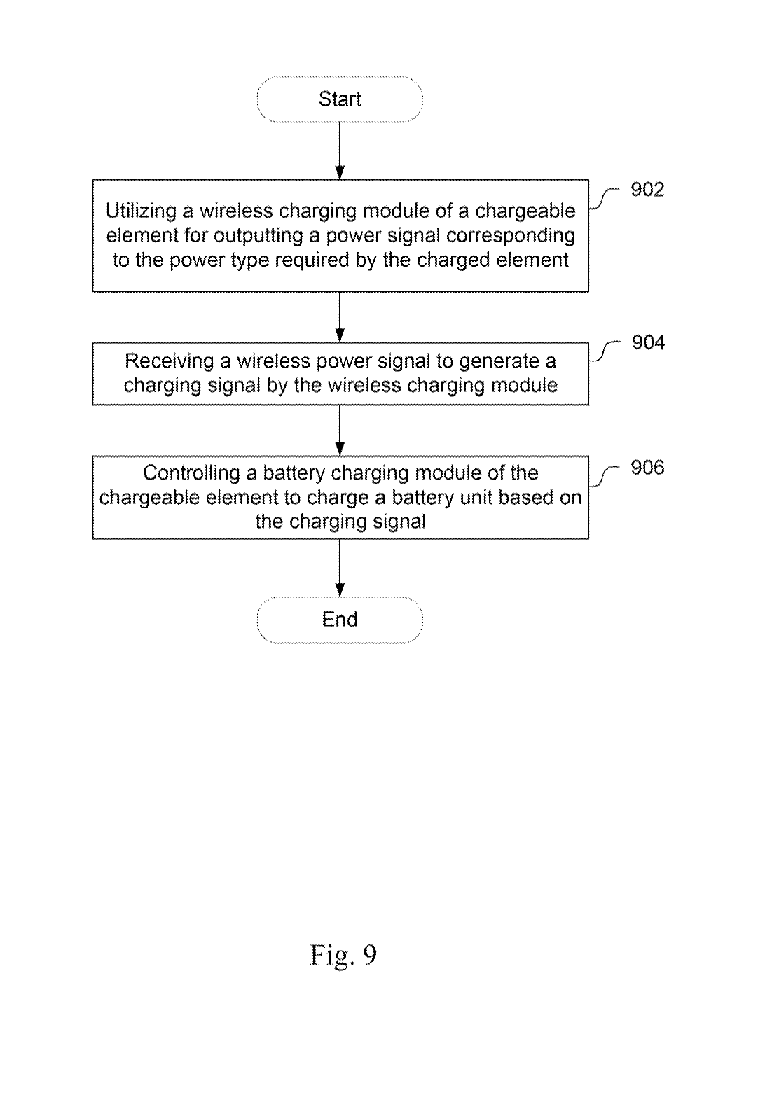

FIG. 9 is a flow chart of a wireless charging method in accordance with one embodiment of the present disclosure. Specifically, the wireless charging method illustrated in FIG. 9 corresponds to operations on chargeable elements and could be applied but not limited to the chargeable element 120 illustrated in FIG. 2. For convenience and clarity, the following description about the wireless charging method is illustrated based on the chargeable element 120 illustrated in FIG. 2.

In step 902, utilize the wireless charging module 122 of the chargeable element 120 for outputting a power signal PS corresponding to the power type required by the chargeable element 120. Then in step 904, receive the wireless power signal WP to generate a charging signal CS by the wireless charging module 122. In step 906, control the battery charging module 124 of the chargeable element 120 to charge the battery unit 126 based on the charging signal CS.

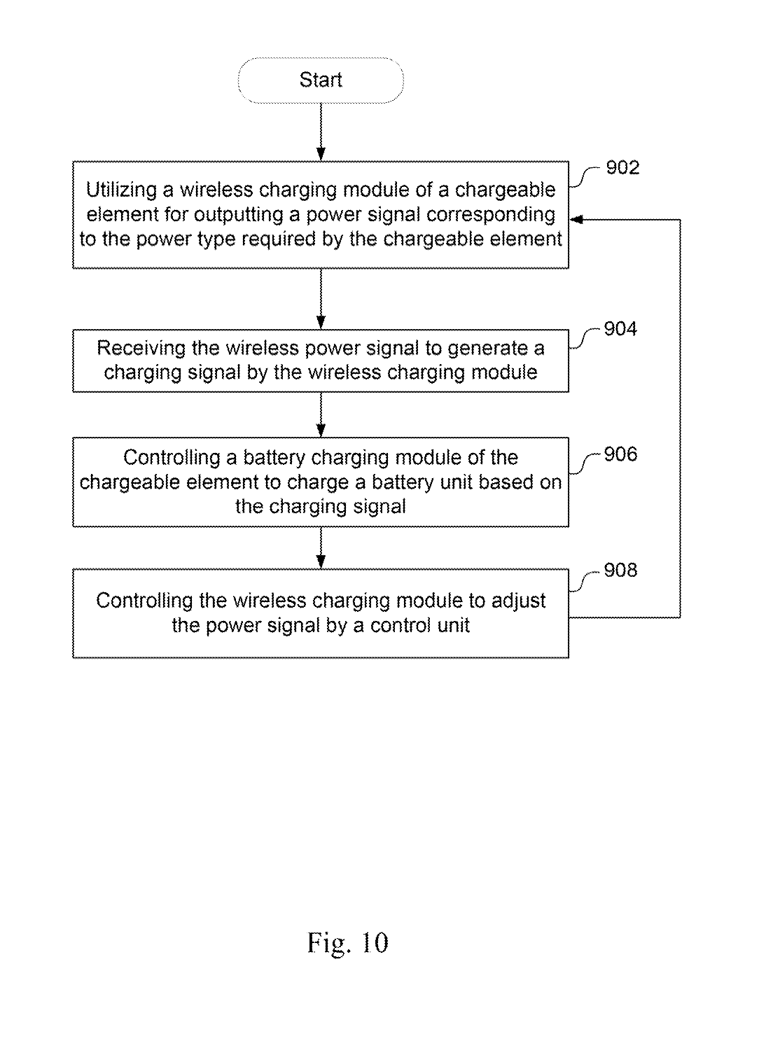

FIG. 10 is a flow chart of a wireless charging method in accordance with one embodiment of the present disclosure. The wireless charging method could be applied but not limited to the chargeable element 120 illustrated in FIG. 3. For convenience and clarity, the following description about the wireless charging method is illustrated based on the chargeable element 120 illustrated in FIG. 3.

Comparing with the wireless charging method illustrated in FIG. 9, in the present embodiment, the wireless charging method further includes step 908. In step 908, the control unit 130 controls the wireless charging module 122 to adjust the power signal PS.

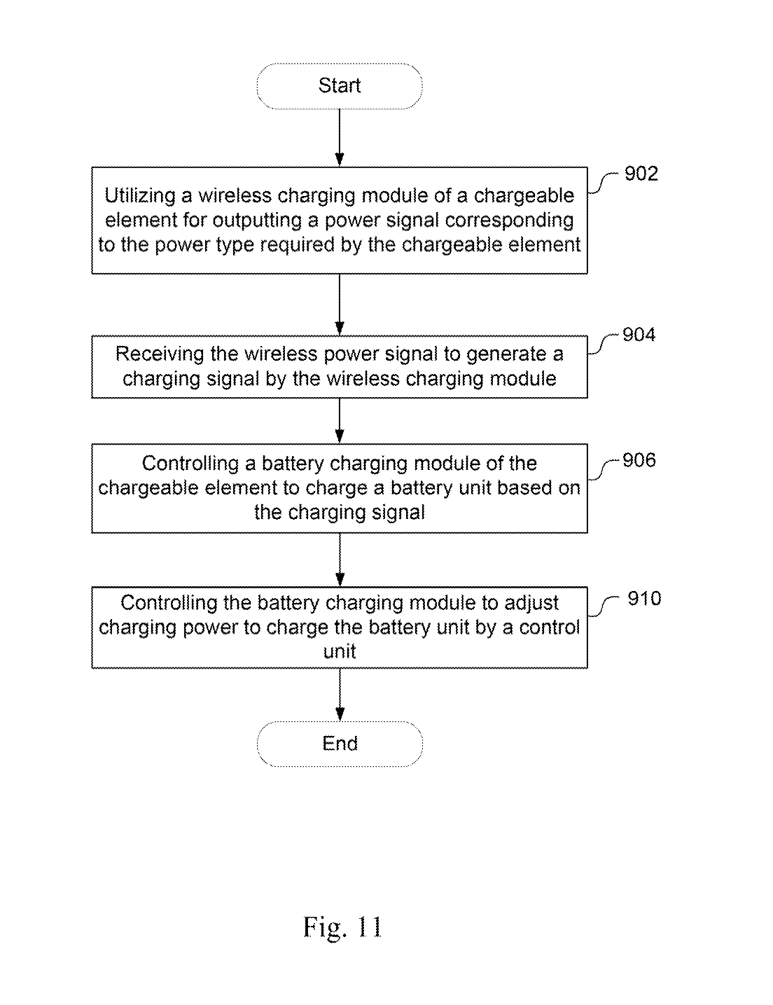

FIG. 11 is a flow chart of a wireless charging method in accordance with one embodiment of the present disclosure. The wireless charging method could be applied but not limited to the chargeable element 120 illustrated in FIG. 5. For convenience and clarity, the following description about the wireless charging method is illustrated based on the chargeable element 120 illustrated in FIG. 5.

Comparing with the wireless charging method illustrated in FIG. 9, in the present embodiment, the wireless charging method further includes step 910. In step 910, the control unit 140 controls the battery charging module 124 to adjust charging power to charge the battery unit 126.

By applying the wireless charging systems and the wireless charging methods illustrated in the abovementioned embodiments of the present disclosure, the wireless power supply could be adjusted to output appropriate wireless power signals according to the power types required by chargeable elements. In this way, a single wireless power supply could charge various kinds of chargeable elements. Also, the chargeable element could dynamically adjust the charging power such that the charging time is reduced, and the battery life is extended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fail within the scope of the following claims.

What is claimed is:

1. A wireless charging system, comprising:
a chargeable element; and
a wireless power supply, configured for generating a wireless power signal to charge the chargeable element, wherein the wireless power supply is further configured for detecting a power type required by the chargeable element, and for adjusting the wireless power signal according to the detected power type.

2. The wireless charging system of claim 1, wherein when power of the chargeable element reaches a setting value, the wireless power supply lowers down output power of the wireless power signal.

3. The wireless charging system of claim 1, wherein the chargeable element comprises:
a wireless charging module, configured for outputting a power signal corresponding to the power type required by the chargeable element, and for receiving the wireless power signal to generate a charging signal;
a battery unit; and
a battery charging module, electrically connected with the wireless charging module and the battery unit, the battery charging module being configured for charging the battery unit according to the charging signal.

4. The wireless charging system of claim 3, wherein the chargeable element further comprises:
a control unit, electrically connected with the wireless charging module, the control unit being configured for controlling the wireless charging module to adjust the power signal.

5. The wireless charging system of claim wherein the chargeable element further comprises:
a control unit, electrically connected with the battery charging module, the control unit being configured for controlling the battery charging module to adjust charging power to charge the battery unit.

6. A wireless charging method comprises:
detecting a power type required by a chargeable element;
adjusting a wireless power signal generated by a wireless power supply according to the detected power type; and
charging the chargeable element with the adjusted wireless power signal.

7. The wireless charging method of claim 6 further comprises:
when power of the chargeable element reaching a setting value, lowering down output power of the wireless power signal generated by the wireless power supply.

8. The wireless charging method of claim 6 further comprises:
utilizing a wireless charging module of the chargeable element for outputting a power signal corresponding to the power type required by the chargeable element;
receiving the wireless power signal to generate a charging signal by the wireless charging module; and
controlling a battery charging module of the chargeable element to charge a battery unit based on the charging signal.

9. The wireless charging method of claim 8 further comprises:
controlling the wireless charging module to adjust the power signal by a control unit.

10. The wireless charging method of claim 8 further comprises:
controlling the battery charging module to adjust charging power to charge the battery unit by a control unit.
